(19) United States
(12) Patent Application Publication
(10) Pub. No.: US 2008/0074993 A1
(43) Pub. Date: Mar. 27, 2008

(54) UMA classmark information

(76) Inventor: Kati Vainola, Hikia (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/527,580

(22) Filed: Sep. 27, 2006

(51) Int. Cl. H04J 3/14; H04L 12/56

(52) U.S. Cl. 370/218; 370/401

(57) ABSTRACT

A network controller device provides an inter-working function between a core network and an access network. The device comprises a first gateway configured to be connected with a switching center server over an interface which enables real-time communication streams, and a second gateway configured to be connected with a terminal over the access network, wherein the connection with the terminal can include a real-time redundancy configuration related to the loss of communication information over this connection with the terminal. The network controller device is adapted to receive information indicating that the terminal supports the real-time redundancy configuration, and to forward the information indicating the terminal's support for the real-time redundancy configuration to the switching center server. Further disclosed is a respective method and system.

### FIELD OF THE INVENTION

The present invention relates to a network controller device with an enhanced inter-working function between a core network and an access network. The present invention also relates to a respective system and method therefor.

### RELATED BACKGROUND ART

Recently, the technologies for providing access to a core network gain more and more varieties. For example, the generic access network (GAN) is the 3^{rd} generation partnership project (3GPP) global standard for subscriber access to mobile voice, data and IMS (IP multimedia subsystem) services over fixed IP (internet protocol) access networks. It is to be noted that GAN is sometimes referred to as the unlicensed mobile access (or UMA). However, throughout this document, the same technology is designated regardless whether referring to “UMA,” which is the more common terminology in present use, or whether referring to “GAN”.

With UMA, mobile operators can leverage the cost and performance advantages of IP access technologies such as DSL (direct subscriber line), cable, Wi-Fi (designating wireless local area networks based on the IEEE 802.11 specifications) to deliver high-quality, low-cost mobile services in the locations where subscribers spend most of their time, that is, the home and office. Specifically, with UMA, subscribers using dual-mode handsets can roam and hand-over between mobile radio access networks (RANs) and wireless LANs (WLANs) as effortlessly and transparently as they move between cells within the GSM (global system for mobile communications) network. Seamless in-call handover between WLANs and mobile RANs ensures that the location and mobility of the user do not impact the services delivered. The subscriber experiences total service and location transparency.

UMA defines a new access network for mobile operators. Like GSM/GPRS (general packet radio service)/EDGE (enhanced data rates for GSM evolution) and UMTS (universal mobile telecommunications service) radio access networks (RANs), a UMA access network leverages the same well-defined, standard interfaces into an operator's existing mobile core network for service delivery.

This logical demarcation between core and access networks enables each of these access network technologies to evolve independently of the core network. This is an important aspect of the appeal of UMA: no new network elements or systems are by default required to an existing mobile core to implement UMA. Unlike GSM or UMTS RANs which utilize expensive private backhaul circuits, expensive base station components and licensed spectrum for wireless coverage, a UMA access network enables operators to leverage their subscribers' existing broadband access connections for backhaul together with the unlicensed spectrum provided by a WLAN access point at the customer's end of the broadband circuit for wireless coverage. A UMA access network is comprised of UMA-enabled devices connected over any broadband IP access connection to a UMA network controller (UNC) located in an operator's core network. UMA uses IP tunneling between the UMA-enabled device and the UNC-SEGW to transparently extend mobile circuit, packet and IMS-based services over any IP access network.

Specifically, the UNC provides the inter-working function between the core mobile network and the IP access network. The UNC connects to mobile core network MSCs (mobile switching centers), SGSNs (serving GPRS support nodes) and AAA (authentication, authorization and accounting) servers through the 3GPP-defined A, Gb, and Wm interfaces, respectively, and behaves as a typical GSM base station controller (BSC) as far as the core network is concerned. This leveraging of standard core network interfaces minimizes the impact on core network systems when deploying the UMA solution.

### SUMMARY OF THE INVENTION

It is an object of the present invention to still more enhance the inter-working function of a network controller between a core network and an access network.

Specifically, according to a first aspect of the present invention, there is provided a network controller device providing an inter-working function between a core network and an access network, comprising a first gateway configured to be connected with a switching center server over an interface which enables real-time communication streams; and a second gateway configured to be connected with a terminal over the access network, wherein the connection with the terminal can include a real-time redundancy configuration related to the loss of communication information over this connection with the terminal; wherein the network controller device is adapted to receive information indicating that the terminal supports the real-time redundancy configuration, and the network controller device is adapted to forward the information indicating the terminal's support for the real-time redundancy configuration to the switching center server.

The network controller device can be an unlicensed mobile access network controller, the switching center server can be a mobile switching center server, and the real-time communication streams can be based on the Real-Time Transport Protocol. In this case, the real-time redundancy configuration can be transmitted as a Real-Time Transport Protocol Redundancy Configuration information element.

Furthermore, the interface may be the A+ interface, and, at the same time or alternatively, the network controller device may be adapted to receive and forward the support information during a discovery/registration phase preceding an unlicensed mobile access call setup including an assignment phase.

According to a second aspect of the present invention, there is provided a method of providing a real-time redundancy configuration, comprising receiving information from a terminal by a network controller device, the information indicating support of the terminal for a real-time redundancy configuration of a connection between the terminal and the network controller device related to the loss of communication information over this connection; and forwarding the information indicating support of the terminal for the real-time redundancy configuration from the network controller device to a switching center server over an interface enabling real-time communication streams.

The network controller device can be an unlicensed mobile access network controller, the switching center server can be a mobile switching center server, and the real-time communication streams can be based on the Real-Time Transport Protocol. In this case, the real-time redundancy configuration can be transmitted as a Real-Time Transport Protocol Redundancy Configuration information element.

Furthermore, the interface may be the A+ interface, and, at the same time or alternatively, the receiving and forwarding may include the transmission of the support information during a discovery/registration phase preceding an unlicensed mobile access call setup including an assignment phase. In the latter case, the forwarding may further include a transmission of the support information as soon as a signaling connection and control part connection has been established.

Further modifications are that the method according to the second aspect may further comprise receiving the support information by the switching center server, and initiating a resource assignment phase by the switching center server in response thereto, including the redundancy configuration, and, at the same time or alternatively, that the method according to the second aspect may further comprise requesting the support information from the terminal by the network controller device.

According to a third aspect of the present invention, there is provided a system for providing a real-time redundancy configuration, comprising a network controller device, a terminal and a switching center server, wherein the network controller device is configured to receive information from the terminal, the information indicating support of the terminal for a real-time redundancy configuration of a connection between the terminal and the network controller device related to the loss of communication information over this connection; and to forward the information indicating support of the terminal for the real-time redundancy configuration to the switching center server over an interface enabling real-time communication streams.

The network controller device can be an unlicensed mobile access network controller, the switching center server can be a mobile switching center server, and the real-time communication streams can be based on the Real-Time Transport Protocol. In this case, the real-time redundancy configuration can be transmitted as a Real-Time Transport Protocol Redundancy Configuration information element.

Furthermore, the interface may be the A+ interface, and, at the same time or alternatively, the network controller device may be further configured to receive and forward the support information during a discovery/registration phase preceding an unlicensed mobile access call setup including an assignment phase. In the latter case, the network controller device may be further configured to forward the support information as soon as a signaling connection and control part connection has been established.

Further modifications of the third aspect according to the present invention are that the switching center server may be configured to receive the support information, and to initiate a resource assignment phase in response thereto, including the redundancy configuration, and, at the same time or alternatively, that the network controller device may be further configured to request the support information from the terminal.

According to a fourth aspect of the present invention there is provided a network controller device providing an inter-working function between a core network and an access network, comprising first gateway means for connecting with switching center means over interface means which enable real-time communication streams; and second gateway means for connecting with terminal means over the access network, wherein the connection with the terminal means can include a real-time redundancy configuration related to the loss of communication information over this connection with the terminal means; wherein the network controller device is adapted to receive information indicating that the terminal means support the real-time redundancy configuration, and the network controller device is adapted to forward the information indicating the terminal's support for the real-time redundancy configuration to the switching center means.

According to a fifth aspect of the present invention, there is provided a system for providing a real-time redundancy configuration, comprising network controller means for receiving information from terminal means, the information indicating support of the terminal means for a real-time redundancy configuration of a connection between the terminal means and the network controller means related to the loss of communication information over this connection; and for forwarding the information indicating support of the terminal means for the real-time redundancy configuration to the switching center means over an interface enabling real-time communication streams.

According to a sixth aspect of the present invention, there is provided a computer program product comprising instructions which are operable to control a data processor, the instructions including: to receive information from a terminal by a network controller device, the information indicating support of the terminal for a real-time redundancy configuration of a connection between the terminal and the network controller device related to the loss of communication information over this connection; and to forward the information indicating support of the terminal for the real-time redundancy configuration from the network controller device to a switching center server over an interface enabling real-time communication streams.

### BRIEF DESCRIPTION OF THE DRAWINGS

The above and further aspects, features, and advantages of the present invention will become readily apparent from the following description of its preferred embodiments which is to be taken in conjunction with the appended drawings, in which:

FIG. 1 shows the location of a conventional UNC in the mobile network as well as functions involved with the UNC;

FIG. 2 shows the distributed UMA architecture; and

FIG. 3 shows the signaling flow for RTP redundancy configuration including the UMA/GAN classmark information element delivery to the MSS.

### PREFERRED EMBODIMENTS OF THE PRESENT INVENTION

The preferred embodiments described in the following serve to illustrate the applicability and enablement of the present invention, but it is to be expressly understood that these embodiments are meant to serve as illustrative examples only, and that they are by no means to be construed as limiting the present invention to the described particularities.

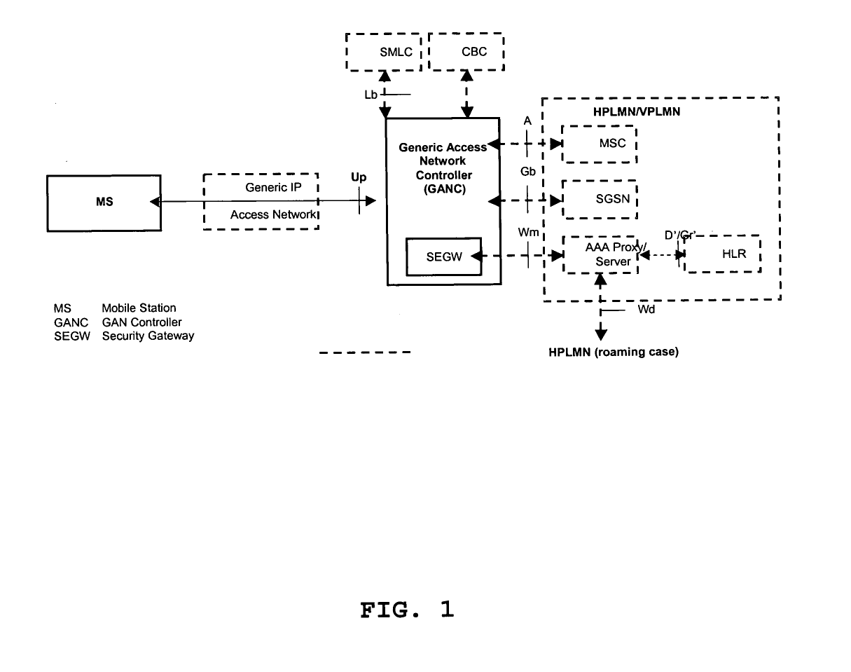

FIG. 1 describes the location of the UNC (generic access network controller-GANC) in the mobile network and shows how the UNC involves multiple, discrete functions, each of which are then outlined further below. The dashed line in FIG. 1 indicates elements which are depicted for a complete understanding, while the elements shown by solid line are more central to the understanding of the present embodiment.

Specifically, downstream, the UNC connects to UMA-enabled devices through the “Up” interface, a UMA-specific protocol running over the IP layer that defines the communications model between the UNC and UMA-enabled devices over an IP access network.

The UNC is responsible for making the IP-based access network appear as a conventional GSM/GPRS/EDGE access network to a mobile core network. UNC functions include the enabling of secure, encrypted communications between the device and the core network, the relaying of GSM/GPRS signaling and bearer traffic across the UMA access network, the handling of set-up and tear-down of voice and data (GPRS) sessions, and the managing of the seamless inter-BSC or inter-MSC handover of active sessions.

The UNC is comprised of four logical functions: UMA control functionality, the user plane functionality for circuit switched services, the user plane functionality for packet switched services and the security gateway. The UMA control functionality manages all control signaling, subscriber management and mobility associated with delivery of mobile circuit and packet services. The user plane functionality for circuit switched services provides VoIP (voice over IP) to TDM (time division multiplexing) transcoding for the voice bearer traffic. This function is required when the UNC is using TDM-based A interface links to MSCs within a home public land mobile network (HPLMN) or a visited PLMN (VPLMN). The user plane functionality for packet switched services provides the interworking for data transport over Up interface to packet flows over Gb interface and when necessary the IP to frame relay (FR) packet formatting required for the Gb interface to SGSN (serving GPRS support node) servers in the network. The security gateway (SEGW) function terminates secure remote access tunnels from UMA-enabled devices over the IP access network. The security gateway function provides mutual authentication for UMA-enabled devices and the UNC, as well as encryption and data integrity for all control and user (voice and data) traffic.

With reference to FIG. 1, UMA specifies the use of three existing 3GPP GSM/GPRS network interfaces from the UNC into the mobile core network. The A interface is the standard GSM interface between a BSC and MSC for delivery of circuit-based services, the Gb interface is the standard GSM interface between a BSC and SGSN for delivery of packet and IMS-based services, and the Wm interface is the standard GSM interface to a AAA server which accesses the HLR (home location register) for subscriber authentication and authorization via the D′/Gr′ interface.

Besides, FIG. 1 also shows the connection of the UNC to a cell broadcast center (CBC) and a serving mobile location center (SMLC) via the Lb interface for supporting location services, and the connection of the AAA proxy/server to a HPLMN via the Wd interface in the roaming case.

Towards the handset, the UMA standard specifies the “Up” interface. The Up interface transports mobile signaling and bearer traffic (circuit, packet and IMS-based) through a secure IPSec (secure IP) tunnel over any IP access network. By tunneling mobile signaling and bearer traffic over IP, by default no modifications to the mobile core network are required to support the full range of mobile features and services. As the UMA Up interface is a full 3GPP standard, device suppliers and network equipment vendors can achieve open interoperability between the two ends of the UMA solution. Device manufacturers can implement the Up client interface within their product lines and be assured that their products will be able to use UMA network equipment operated by any service provider, the same as in present GSM environment.

While above are described the basic capabilities, features and functions of a standard UMA environment, recently, there have been proposals to extend the capabilities of the UMA network to encompass an additional, rich feature set.

Central to this is an IP-based UMA network controller (UNC) as e.g. introduced by the present applicant/assignee. The UNC is intended to provided IP-based access for network evolution and its architecture comprises the following components.

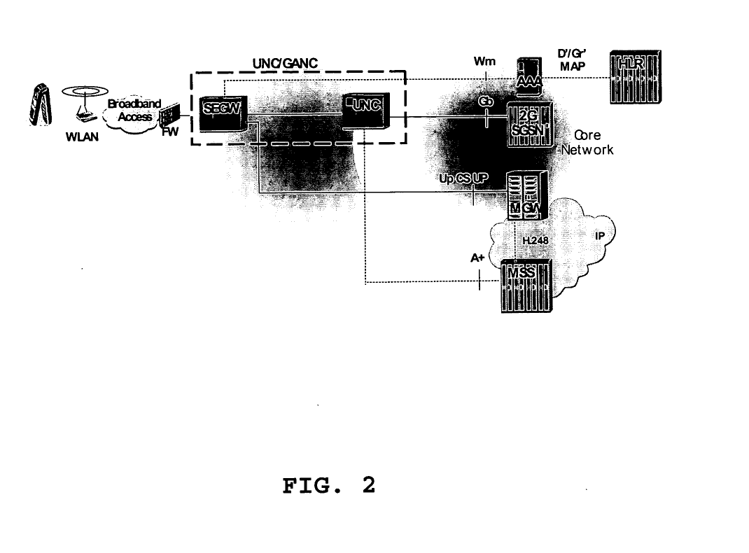

As shown in FIG. 2, the UMA control function UNC/GANC includes all signaling, subscriber management and mobility associated with delivery of mobile voice and data services over the UMA access network. The UNC provides the UMA control and user plane functionality for packet switched services. Circuit bearer traffic does not pass through the UNC but instead flows directly from the security gateway (SeGW) to the media gateway (MGW), enabling the possibility of a distributed architecture. The user plane functionality for packet switched services relays packet control and bearer information to the SGSN Gb interface. The standard security gateway (SeGW) component terminates IPSec encrypted tunnels from each UMA-enabled device and provides the authentication control point for UMA subscribers. The standard media gateway (MGW) component provides the circuit gateway function of the UNC.

Such a distributed UMA architecture provides a number of advanced and unique features that enable the operator to substantially customize and differentiate their service offerings within the standard UNC platform. These include an architecture that supports distributed system deployments, the enhanced A interface (A+) which enables VoIP RTP (Real-Time Transport Protocol) streams from devices to flow directly to a media gateway, and open standards-based service access controls.

Accordingly, this UMA solution is utilizing an MSC server (MSS) architecture as a CS (circuit switched) core optimized architecture with a direct Up interface connection from the SeGW to the MGW, which has UMA compliant transcoding facilities. This kind of architecture allows a limitation of need of transcoding only to the edge of the IP backbone network. For instance, if a call is made from UMA access to the PSTN (public switched telephone network), then it is possible to optimize the MGW selection in order to use IP as much as possible. Also, no dedicated user plane functionality for circuit switched services is required in UMA access network, but this can be handled with a single MGW device at the core network.

This UMA solution for MSC server uses a slightly modified BSSAP (base station system application part) UMA protocol to benefit fully from the split architecture (control vs. user plane) on the UMA access side, as well as in the CS core network. That is, as developed by the SIGTRAN working group of the IETF (internet engineering task force) that produced specifications for a family of protocols that provide reliable datagram service and user layer adaptations for SS7 (signaling system 7) and ISDN (integrated services digital network) communications protocols, the stream control transmission protocol can be used to carry PSTN signalling over IP.

In the A+ interface, the BSSMAP (base station subsystem management application part) UMA messages used in assignment and handover procedures contain a new information element (IE) describing the UMA-specific information (for example, the address and port information of the IP resource reserved from the MGW, and RTP payload type) used for UMA user plane establishment. The A+ interface uses SS7 (signaling system #7) over IP as transport for signaling.

UMA/GAN specifications in release 6 introduce the feature “RTP redundancy configuration” to overcome a possible voice quality decrease in case an intermediate IP-network from end user's broadband access to the UNC is affected by packet loss. Apparently, support for this feature increases the attractiveness of the above described enhanced UMA solution and the MGW by enabling the possibility to offer a better voice quality from calls originated and terminated from/to UMA.

The UMA/GAN specifications define that the RTP redundancy configuration feature can be used only, if the terminal indicates its support for the feature in the UMA/GAN classmark IE. The UMA/GAN classmark IE is received from the terminal by the UNC in DISCOVERY REQUEST and REGISTER REQUEST messages.

According to an embodiment of the present invention, the feature RTP redundancy configuration is leveraged.

That is, the present inventors have recognized that in the above described enhanced UMA solution for MSS as exemplified in FIG. 2, also the MSS controlling the MGW which terminates the user plane for circuit switched services needs the GAN classmark information before the assignment phase to make the decision whether the feature can be used or not and the related information sent in the BSSAP Assignment Request message.

Hence, according to an embodiment of the present invention, a requirement is complied with, which is for the UNC to send the UMA/GAN classmark information element to the MSS as soon as a SCCP (signaling connection and control part) connection at the A+ interface has been established.

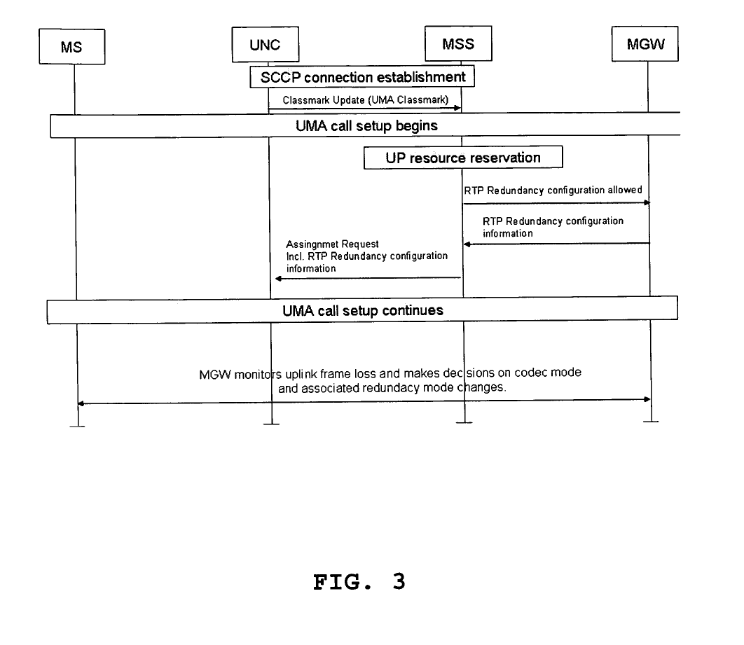

That is, the UNC shall forward the UMA/GAN classmark information received from the MS (mobile station) during the discovery/registration phase to the MSS as soon as a SCCP connection has been established. This is shown in FIG. 3.

Specifically, once a SCCP connection is established, the UNC sends a message comprising a UMA classmark update to the MSS. As described above, the UMA/GAN classmark IE may be received by the UNC from the terminal in DISCOVERY REQUEST and REGISTER REQUEST messages, i.e. also during the discovery/registration phase.

Thereafter, the actual UMA call setup starts and the Up interface resource reservation begins. As illustrated in FIG. 3, the MSS and the MGW exchange messages in which the RTP redundancy configuration is informed. This configuration information is sent by the MSS to the UNC in an assignment request message. The UMA call setup may then continue as conventionally known.

With the RTP redundancy configuration feature thus effectively implemented, the MGW is enabled to make decisions on a used codec mode and associated redundancy mode changes based on monitoring uplink quality e.g. frame loss, and jitter.

Accordingly, the use of the RTP redundancy configuration feature can be enabled in the distributed UMA network solution involving a respective MSS. Hence, a better voice quality is obtained also in cases when the intermediate IP network between the UMA access point and UNC suffers from packet loss.

This embodiment can be advantageously applied to UMA releases where the RTP redundancy configuration feature is implemented, and where the RTP redundancy configuration is already supported by respective UMA terminals.

Furthermore, in view of the fact that the RTP redundancy configuration feature is standardized already in UMA specifications as well as in release 6 of the GAN specifications, the above described UMA classmark delivery can be very advantageously included in case of standardizing further GAN enhancements for described UMA distributed architecture.

According to further embodiments of the present invention, the new message to deliver the UMA/GAN classmark information to the MSS could be either dedicated for this information delivery, or contain also other information that the UNC has received from the MS during UMA discovery/registration phase. Such information (e.g. access point (AP) radio identity, AP location, geographical location, etc.) could be further used in the MSS for example controlling the connection e.g. based on operator policies.

In accordance with one or more of the embodiments of the present invention, the RTP redundancy configuration can be utilized only if the terminal supports it (according to specification 3GPP TS 43.318). The MGW is responsible for the user plane uplink quality measurements in the distributed UMA architecture concept (the user plane goes directly to MGW which belongs to the core network and not to the UNC, as shown in FIG. 2). The RTP redundancy configuration needs to be negotiated between MS and MGW, so MSS/MGW needs to receive the information from the terminal, whether it supports the feature. The support information is delivered by the GAN classmark to the UNC (according to the specification 3GPP TS 43.318), but it cannot be delivered in the normal BSSAP signaling of the A interface (according to the specification 3GPP TS 48.008).

Thus, the RTP redundancy configuration support information needs to be forwarded over the A+ interface to MSS/MGW so that MSS/MGW can negotiate the RTP redundancy configuration parameters with the terminal. With respect thereto, there are two alternative implementation options: The UNC can forward the UMA/GAN classmark information received from the MS during the Discovery/Registration phase to the MSS as soon as an SCCP connection has been established. The UNC requests the support information from the terminal and informs the MSS/MGW about the RTP redundancy configuration parameter set to be used. In case the control shall be kept in the core network, the first option has to be chosen, though, since it is thus possible to have the MGW dictate the parameter set in order to eliminate the possibility that the chosen parameter set would be unusable by the MGW.

Hence, the advantage is achieved to enable the RTP redundancy configuration feature in an MSC Server architecture for Unlicensed Mobile Access (UMA) by delivering the RTP redundancy configuration support information over the A+ interface to MSS/MGW so that MSS/MGW can negotiate the RTP redundancy configuration parameters with the terminal.

Thus, according to embodiments of the present invention, a network controller device provides an inter-working function between a core network and an access network. The device comprises a first gateway configured to be connected with a switching center server over an interface which enables real-time communication streams, and a second gateway configured to be connected with a terminal over the access network, wherein the connection with the terminal can include a real-time redundancy configuration related to the loss of communication information over this connection with the terminal. The network controller device is adapted to receive information indicating that the terminal supports the real-time redundancy configuration, and to forward the information indicating the terminal's support for the real-time redundancy configuration to the switching center server. Further embodiments concern a respective method and system.

What has been described above is what are presently considered to be preferred embodiments of the present invention. However, as is apparent to the skilled reader, these are provided for illustrative purposes only and are in no way intended to that the present invention is restricted thereto. Rather, it is the intention that all variations and modifications be included which fall within the spirit and scope of the appended claims.

1. A network controller device providing an inter-working function between a core network and an access network, comprising
a first gateway configured to be connected with a switching center server over an interface which enables real-time communication streams; and
a second gateway configured to be connected with a terminal over the access network, wherein the connection with the terminal can include a real-time redundancy configuration related to the loss of communication information over this connection with the terminal; wherein
the network controller device is adapted to receive information indicating that the terminal supports the real-time redundancy configuration, and
the network controller device is adapted to forward the information indicating the terminal's support for the real-time redundancy configuration to the switching center server.

2. The network controller device according to claim 1, wherein the network controller device is an unlicensed mobile access network controller, the switching center server is a mobile switching center server, and the real-time communication streams are based on the Real-Time Transport Protocol.

3. The network controller device according to claim 1, wherein the interface is the A+ interface.

4. The network controller device according to claim 2, wherein the real-time redundancy configuration is transmitted as a Real-Time Transport Protocol Redundancy Configuration information element.

5. The network controller device according to claim 1, wherein the network controller device is adapted to receive and forward the support information during a discovery/registration phase preceding an unlicensed mobile access call setup including an assignment phase.

6. A method of providing a real-time redundancy configuration, comprising
receiving information from a terminal by a network controller device, the information indicating support of the terminal for a real-time redundancy configuration of a connection between the terminal and the network controller device related to the loss of communication information over this connection; and
forwarding the information indicating support of the terminal for the real-time redundancy configuration from the network controller device to a switching center server over an interface enabling real-time communication streams.

7. The method according to claim 6, wherein the network controller device is an unlicensed mobile access network controller, the switching center server is a mobile switching center server, and the real-time communication streams are based on the Real-Time Transport Protocol.

8. The method according to claim 6, wherein the interface is the A+ interface.

9. The method according to claim 7, wherein the real-time redundancy configuration is transmitted as a Real-Time Transport Protocol Redundancy Configuration information element.

10. The method according to claim 6, wherein receiving and forwarding includes the transmission of the support information during a discovery/registration phase preceding an unlicensed mobile access call setup including an assignment phase.

11. The method according to claim 10, wherein the forwarding further includes a transmission of the support information as soon as a signaling connection and control part connection has been established.

12. The method according to claim 6, further comprising receiving the support information by the switching center server, and initiating a resource assignment phase by the switching center server in response thereto, including the redundancy configuration.

13. The method according to claim 6, further comprising requesting the support information from the terminal by the network controller device.

14. A system for providing a real-time redundancy configuration, comprising a network controller device, a terminal and a switching center server, wherein the network controller device is configured
to receive information from the terminal, the information indicating support of the terminal for a real-time redundancy configuration of a connection between the terminal and the network controller device related to the loss of communication information over this connection; and
to forward the information indicating support of the terminal for the real-time redundancy configuration to the switching center server over an interface enabling real-time communication streams.

15. The system according to claim 14, wherein the network controller device is an unlicensed mobile access network controller, the switching center server is a mobile switching center server, and the real-time communication streams are based on the Real-Time Transport Protocol.

16. The system according to claim 14, wherein the interface is the A+ interface.

17. The system according to claim 15, wherein the real-time redundancy configuration is transmitted as a Real-Time Transport Protocol Redundancy Configuration information element.

18. The system according to claim 14, wherein the network controller device is further configured to receive and forward the support information during a discovery/registration phase preceding an unlicensed mobile access call setup including an assignment phase.

19. The system according to claim 18, wherein the network controller device is further configured to forward the support information as soon as a signaling connection and control part connection has been established.

20. The system according to claim 14, wherein the switching center server is configured to receive the support information, and to initiate a resource assignment phase in response thereto, including the redundancy configuration.

21. The system according to claim 14, wherein the network controller device is further configured to request the support information from the terminal.

22. A network controller device providing an inter-working function between a core network and an access network, comprising
first gateway means for connecting with switching center means over interface means which enable real-time communication streams; and
second gateway means for connecting with terminal means over the access network, wherein the connection with the terminal means can include a real-time redundancy configuration related to the loss of communication information over this connection with the terminal means; wherein
the network controller device is adapted to receive information indicating that the terminal means support the real-time redundancy configuration, and
the network controller device is adapted to forward the information indicating the terminal's support for the real-time redundancy configuration to the switching center means.

23. A system for providing a real-time redundancy configuration, comprising network controller means
for receiving information from terminal means, the information indicating support of the terminal means for a real-time redundancy configuration of a connection between the terminal means and the network controller means related to the loss of communication information over this connection; and
for forwarding the information indicating support of the terminal means for the real-time redundancy configuration to the switching center means over an interface enabling real-time communication streams.

24. A computer program product comprising instructions which are operable to control a data processor, the instructions including:
to receive information from a terminal by a network controller device, the information indicating support of the terminal for a real-time redundancy configuration of a connection between the terminal and the network controller device related to the loss of communication information over this connection; and
to forward the information indicating support of the terminal for the real-time redundancy configuration from the network controller device to a switching center server over an interface enabling real-time communication streams.
